(19) United States
(12) Patent Application Publication
(10) Pub. No.: US 2005/0250905 A1
(43) Pub. Date: Nov. 10, 2005

(54) Impact-modified polycarbonate molding compositions

(76) Inventors: Moh-Ching O. Chang, Wexford, PA (US); James Y.J. Chung, Wexford, PA (US)

Correspondence Address: Patent Department;Bayer Polymers LLC, 100 Bayer Road, Pittsburgh, PA, 15205-9741, US

(21) Appl. No.: 10/838,733

(22) Filed: May 4, 2004

(51) Int. Cl. C08L 51/00

(52) U.S. Cl. 525/67

(57) ABSTRACT

A thermoplastic molding composition containing polycarbonate, vinyl copolymer and a compound rubber graft copolymer that contains a polyorganosiloxane is disclosed. The composition is characterized in its improved mechanical properties, most especially Izod impact strength of articles having thickness of at least ¼″ molded of the composition.

### FIELD OF THE INVENTION

The invention concerns thermoplastic molding compositions and more particularly compositions containing aromatic polycarbonate and vinyl copolymer

### SUMMARY OF THE INVENTION

A thermoplastic molding composition containing polycarbonate, vinyl copolymer and a compound rubber graft copolymer that contains a polyorganosiloxane is disclosed. The composition is characterized in its improved mechanical properties, most especially Izod impact strength of molded articles of the composition that have a thickness of at least 1/4 inch.

### BACKGROUND OF THE INVENTION

Polycarbonate resins are known for their excellent mechanical properties making them useful in a wide variety of applications. A shortcoming of such resins is the relatively low impact strength (Izod) of molded articles having thick sections. A great number of patents are testament to the efforts made to find solutions to this problem.

U.S. Pat. No. 5,132,359 disclosed a compound rubber type graft copolymer that is an essential component of the composition of the present invention. This compound rubber type graft copolymer is disclosed in the context of a vinyl chloride resin composition. There is nothing apparent in this document to suggest the incorporation of the graft copolymer in the resinous component of the present invention.

The object of the work leading to the present invention was to develop a polycarbonate molding composition that while retaining the traditionally high level of mechanical properties further exhibits good impact resistance at thicker sections.

### DETAILED DESCRIPTION OF THE INVENTION

The inventive thermoplastic composition comprises:
(A) 10 to 99 percent of aromatic polycarbonate resin, and
(B) 90 to 1 percent of a vinyl copolymer and
(C) 1 to 30 parts per one hundred parts (pph) by weight of the total of A and B of a compound rubber graft copolymer.

In a preferred embodiment the composition comprises
(A) 20 to 95 percent of aromatic polycarbonate resin,
(B) 80 to 5 percent of a vinyl copolymer and
(C) 2 to 25 pph of a compound rubber graft copolymer.

In the most preferred embodiment, A) is present in an amount of 40 to 90 percent, B) is present in an amount of 60 to 10 percent and C) amounts to 2 to 15 pph. The percents refer to the total weight of component A and B.

Suitable polycarbonate for preparing the inventive composition is any of homopolycarbonates, copolycarbonates and mixtures thereof. The polycarbonates generally have a weight average molecular weight of 12,000 to 36,000, preferably 16,000 to 32,000 and their melt flow rate, per ASTM D-1238 at 300° C., is about 5 to about 40 g/10 min., preferably about 10 to 30 g/10 min. They may be prepared, for example, by the known diphasic interface process from a carbonic acid derivative such as phosgene and dihydroxy compounds by polycondensation (see German Offenlegungsschriften 2,063,050; 2,063,052; 1,570,703; 2,211,956; 2,211,957 and 2,248,817; French Patent 1,561,518; and the monograph by H. Schnell, “Chemistry and Physics of Polycarbonates”, Interscience Publishers, New York, N.Y., 1964, all incorporated herein by reference).

In the present context, dihydroxy compounds suitable for the preparation of the polycarbonates of the invention conform to the structural formulae (1) or (2). 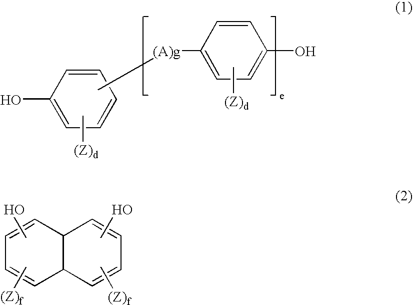
wherein
A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom, —SO— or —SO₂ or a radical conforming to 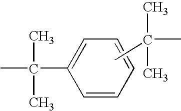
e and g both denote the number 0 to 1;
Z denotes F, Cl, Br or C₁-C₄-alkyl and if several Z radicals are substituents in one aryl radical, they may be identical or different from one another;
d denotes an integer from 0 to 4; and
f denotes an integer from 0 to 3.

Among the dihydroxy compounds useful in the practice of the invention are hydroquinone, resorcinol, bis-(hydroxyphenyl)-alkanes, bis-(hydroxyphenyl)-ethers, bis-(hydroxyphenyl)-ketones, bis-(hydroxyphenyl)-sulfoxides, bis-(hydroxyphenyl)-sulfides, bis-(hydroxyphenyl)-sulfones, dihydroxydiphenyl cycloalkanes, and α,α-bis-(hydroxyphenyl)-diisopropyl-benzenes, as well as their nuclear-alkylated compounds. These and further suitable aromatic dihydroxy compounds are described, for example, in U.S. Pat. Nos. 5,227,458; 5,105,004; 5,126,428; 5,109,076; 5,104,723; 5,086,157; 3,028,356; 2,999,835; 3,148,172; 2,991,273; 3,271,367; and 2,999,846, all incorporated herein by reference.

Further examples of suitable bisphenols are 2,2-bis-(4-hydroxyphenyl)-propane (bisphenol A), 2,4-bis-(4-hydroxyphenyl)-2-methylbutane, 1,1-bis-(4-hydroxyphenyl)-cyclohexane, α,α′-bis-(4-hydroxyphenyl)-p-diisopropylbenzene, 2,2-bis-(3-methyl-4-hydroxyphenyl)propane, 2,2-bis-(3-chloro-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfide, bis-(3,5-dimethyl-4-hydroxyphenyl)-sulfoxide, bis-(3,5-dimethyl-4-hydroxyphenyl)-sulfone, dihydroxybenzophenone, 2,4-bis-(3,5-dimethyl-4-hydroxyphenyl)-cyclohexane, α,α′-bis-(3,5-dimethyl-4-hydroxyphenyl)-p-diisopropyl-benzene and 4,4′-sulfonyl diphenol.

Examples of particularly preferred aromatic bisphenols are 2,2-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-bis-(4-hydroxyphenyl)-3,3,5-trimethylcyclohexane.

The most preferred bisphenol is 2,2-bis-(4-hydroxyphenyl)-propane (bisphenol A).

The polycarbonates of the invention may entail in their structure units derived from one or more of the suitable bisphenols.

Among the resins suitable in the practice of the invention is phenolphthalein-based polycarbonate, copolycarbonates and terpolycarbonates such as are described in U.S. Pat. Nos. 3,036,036 and 4,210,741, both incorporated by reference herein.

The polycarbonates of the invention may also be branched by condensing therein small quantities, e.g., 0.05 to 2.0 mol % (relative to the bisphenols) of polyhydroxy compounds.

Polycarbonates of this type have been described, for example, in German Offenlegungsschriften 1,570,533; 2,116,974 and 2,113,374; British Patents 885,442 and 1,079,821 and U.S. Pat. No. 3,544,514. The following are some examples of polyhydroxy compounds which may be used for this purpose: phloroglucinol; 4,6-dimethyl-2,4,6-tri-(4-hydroxyphenyl)-heptane; 1,3,5-tri-(4-hydroxyphenyl)-benzene; 1,1,1-tri-(4-hydroxyphenyl)-ethane; tri-(4-hydroxyphenyl)-phenylmethane; 2,2-bis-[4,4-(4,4′-dihydroxydiphenyl)]-cyclohexyl-propane; 2,4-bis-(4-hydroxy-1-isopropylidine)-phenol; 2,6-bis-(2′-dihydroxy-5′-methylbenzyl)-4-methylphenol; 2,4-dihydroxybenzoic acid; 2-(4-hydroxyphenyl)-2-(2,4-dihydroxyphenyl)-propane and 1,4-bis-(4,4′-dihydroxytriphenylmethyl)-benzene. Some of the other polyfunctional compounds are 2,4-dihydroxy-benzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates of the invention are polycondensation in a homogeneous phase and transesterification. The suitable processes are disclosed in the incorporated herein by reference, U.S. Pat. Nos. 3,028,365; 2,999,846; 3,153,008; and 2,991,273.

The preferred process for the preparation of polycarbonates is the interfacial polycondensation process.

Other methods of synthesis in forming the polycarbonates of the invention, such as disclosed in U.S. Pat. No. 3,912,688, incorporated herein by reference, may be used.

Suitable polycarbonate resins are available in commerce, for instance, Makrolon FCR, Makrolon 2600, Makrolon 2800 and Makrolon 3100, all of which are bisphenol based homopolycarbonate resins differing in terms of their respective molecular weights and characterized in that their melt flow indices (MFR) per ASTM D-1238 are about 16.5 to 24, 13 to 16, 7.5 to 13.0 and 3.5 to 6.5 g/10 min., respectively. These are products of Bayer Polymers LLC of Pittsburgh, Pa.

A polycarbonate resin suitable in the practice of the invention is known and its structure and methods of preparation have been disclosed, for example, in U.S. Pat. Nos. 3,030,331; 3,169,121; 3,395,119; 3,729,447; 4,255,556; 4,260,731; 4,369,303 and 4,714,746 all of which are incorporated by reference herein.

The vinyl (co)polymers suitable in the context of the present invention is a polymers or copolymer of at least one monomer selected from the group comprising vinyl aromatics, vinyl cyanides (unsaturated nitriles), (meth)acrylic acid (C₁-C₈) alkyl esters, unsaturated carboxylic acids and derivatives (such as anhydrides and imides) of unsaturated carboxylic acids. Particularly suitable are (co)polymers containing at least one monomer selected from the group comprising styrene, α-methyl styrene, acrylic acid, methacrylic acid, methacrylic acid (C₁ to C₄) alkyl ester, acrylonitrile and maleic anhydride.

The vinyl (co)polymer may be produced by known methods such as are disclosed in U.S. Pat. Nos. 4,414,370, 4,529,787, 4,546,160 and 5,508,366, all incorporated herein by reference.

Preferably, the vinyl (co)polymer is a copolymer of 50 to 99 wt. %, in particular 50 to 90, more preferably 55 to 85, most particularly preferably 60 to 80 wt. % of vinyl aromatics and/or ring-substituted vinyl aromatics (such as, e.g., styrene, α-methyl styrene, p-methyl styrene, p-chlorostyrene) and/or methacrylic acid (C₁-C₈) alkyl esters (such as methyl methacrylate and ethyl methacrylate) and 1 to 50 wt. %, in particular 10 to 50, more preferably 15 to 45, most particularly preferably 20 to 40 wt. % of vinyl cyanides (unsaturated nitriles, such as, acrylonitrile and methacrylonitrile) and/or (meth)acrylic acid (C₁-C₈) alkyl esters (such as methyl methacrylate, n-butyl acrylate and t-butyl acrylate) and/or derivatives (such as, anhydrides and imides) of unsaturated carboxylic acids (for example, maleic anhydride and N-phenyl maleinimide)

Preferred embodiment entails a copolymer of a first group of monomers consisting of styrene, α-methyl styrene and methyl methacrylate, and a second group of monomers-consisting of acrylonitrile, maleic anhydride and methyl methacrylate.

Particularly preferred comonomers are styrene and acrylonitrile. Further preferred is a vinyl (copolymer of styrene and acrylonitrile wherein content of acrylonitrile is 15 to 35 percent, preferably 20 to 27 percent relative to the weight of the copolymer. The preferred weight average molecular weight of the copolymer is 40 to 240, more preferably 80 to 200 kg/mol.

The compound rubber graft copolymer (herein “graft copolymer”) suitable in the context of the inventive composition, refers to a copolymer disclosed in U.S. Pat. No. 5,132,359, the specification of which is incorporated herein by reference. Specifically, the graft copolymer is one wherein one or more vinyl monomers are graft-polymerized onto a compound rubber that has a weight average particle diameter of 0.01 to 10, preferably 0.04 to 1 μm and possesses such as a structure that 1 to 10 wt. %, preferably 3 to 10 wt. %, more preferably 5 to 10 wt. % of a polyorganosiloxane rubber component and 90 to 99 wt. %, preferably 90 to 97 wt. %, more preferably 90 to 95 wt. % of a polyalkyl (meth)acrylate rubber component are entangled in an inseparable fashion. The total amount of the polyorganosiloxane rubber component and the polyalkyl (meth)acrylate rubber component preferably being 100 wt. %.

Emulsion polymerization is suitable for the preparation of the compound rubber of the invention. It is preferred that firstly a latex of the polyorganosiloxane rubber is prepared, and that the rubber particles of the latex are impregnated with an alkyl (meth)acrylate and the alkyl (meth)acrylate is subjected to polymerization.

The polyorganosiloxane rubber constituting the above compound rubber may be prepared by emulsion polymerization using an organosiloxane and a crosslinking agent, a graftlinking agent may additionally be used.

Examples of the organosiloxane include cyclic siloxanes of at least a three-member ring, preferably 3 to 6-membered cyclosiloxanes. For example, hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, and octaphenylcyclotetrasiloxane may be mentioned. These may be used alone or in combination as a mixture of two or more different types. The organosiloxane is used in an amount of at least 50 wt. %, preferably at least 70 wt. %, relative to the weight of the polyorganosiloxane rubber component.

Suitable crosslinking agents are trifunctional or tetra functional silane compounds such as trimethoxymethylsilane, triethoxyphenylsilane, tetramethoxysilane, tetraethoxysilane, tetra-n-propoxysilane, and tetrabutoxysilane. Particularly useful are tetra functional crosslinking agents and of these, tetraethoxysilane is especially preferable. The crosslinking agent is used in an amount of 0.1 to 30% relative to the weight of the polyorganosiloxane rubber component.

Suitable graftlinking agents include compounds capable of forming a unit represented by the formulas:
CH₂═CR²COO—(CH₂)ₚ—SiR¹ₙO_{(3-n)/2} (I)
CH₂═CH—SiR¹ₙO_{(3-n)/2}, (II)
or
HS—(—CH₂)ₚ—R¹ₙO_{(3-n)/2} (III)
wherein R¹ is a methyl group, an ethyl group, a propyl group, or a phenyl group, R² is a hydrogen atom, or a methyl group, n is 0, 1, or 2, and p is 1 to 6.

A (meth)acryloyloxysiloxane capable of forming the unit of the formula (I) has a high graft efficiency and thus is capable of forming effective graft chains, and it is advantageous from the viewpoint of providing impact resistance. A methacryloyloxysiloxane is particularly preferable as the compound capable of forming the unit of the formula (I). Specific examples of the methacryloyloxysiloxane include β-methacryloyloxy-ethyldimethoxymethylsilane, γ-methacryloyloxypropyl-methoxydimethylsilane, γ-methacryloyloxy-propyldimethoxymethylsilane, γ-methacryloyloxypropyl-trimethoxysilane, γ-methacryloyloxypropylethoxydiethylsilane, γ-methacryloyloxypropyldiethoxymethyl-silane, and δ-methacryloyloxybutyldiethoxymethylsilane. The grafting agent is used in an amount of 0 to 10 wt. % of the polyorganosiloxane rubber component.

The latex of this polyorganosiloxane rubber component may be produced by known processes such as were disclosed in U.S. Pat. Nos. 2,891,290 and 3,294,725. In the present invention, such a latex is preferably produced, for example, in such a manner that a solution mixture of the organosiloxane, the crosslinking agent and, if desired, the graftlinking agent are subjected to shear-mixing with water by means of, e.g., a homogenizer in the presence of a sulfonic acid type emulsifier such as an alkylbenzenesulfonic acid and an alkylsulfonic acid. An alkylbenzenesulfonic acid is preferable since it serves not only as an emulsifier for the organosiloxane but also as a polymerization initiator. Further, it is preferable to combine a metal salt of an alkylbenzenesulfonic acid, or a metal salt of an alkylsulfonic acid, since such combined use is effective for maintaining the polymer under a stabilized condition during the graft polymerization.

Next, the polyalkyl (meth)acrylate rubber component constituting the compound rubber may be prepared by using an alkyl (meth)acrylate, a crosslinking agent and a graftlinking agent as described below.

Examples of the alkyl (meth)acrylate include alkyl acrylates such as methyl acrylate, ethyl acrylate, n-propyl acrylate, n-butyl acrylate, and 2-ethylhexyl acrylate, and alkyl methacrylates such as hexyl methacrylate, 2-ethylhexyl methacrylate, and n-lauryl methacrylate, with n-butyl acrylate preferably used.

Examples of the crosslinking agent include ethylene glycol dimethacrylate, propylene glycol dimethacrylate, 1,3-butylene glycol dimethacrylate, and 1,4-butylene glycol dimethacrylate.

Examples of the graftlinking agent include allyl methacrylate, trially cyanurate and triallyl isocyanurate. Allyl methacrylate can be used also as a crosslinking agent.

The crosslinking and graftlinking agents may be used alone or in combination as a mixture of two or more different types. The total amount of such crosslinking and graftlinking agents is 0.1 to 20% relative to the weight of the polyalkyl (meth)acrylate rubber component.

The polymerization of the polyalkyl (meth)acrylate rubber component is conducted by adding a monomer mixture of the alkyl (meth)acrylate, the crosslinking agent and the graftlinking agent into the latex of the polyorganosiloxane rubber component neutralized by the addition of an aqueous solution of an alkali such as sodium hydroxide, potassium hydroxide, or sodium carbonate, and impregnating the monomer into the polyorganosiloxane rubber particles, followed by addition of a conventional radical polymerization initiator and heating the mixture to bring about polymerization. As the polymerization progresses, a crosslinked network of a polyalkyl (meth)acrylate rubber entangled with the crosslinked network of the polyorganosiloxane rubber will be formed to obtain a latex of a compound rubber wherein the polyorganosiloxane rubber component and the polyalkyl (meth)acrylate rubber component are entangled in an inseparable fashion. In carrying out the present invention, as the compound rubber, it is preferable to use a compound rubber wherein the main skeleton of the polyorganosiloxane rubber component has repeating units of dimethylsiloxane, and the main skeleton of the polyalkyl (meth)acrylate rubber component has repeating units of n-butyl acrylate.

The compound rubber thus prepared by emulsion polymerization is graft-copolymerized with at least one vinyl monomer. The gel content of the compound rubber measured by extraction with toluene at 90° C. for 12 hours is at least 80% by weight.

The vinyl monomer to be graft-polymerized onto this compound rubber may one or more members selected from the group consisting of aromatic alkenyl compound such as styrene, α-methylstyrene, or vinyltoluene; a methacrylate such as methyl methacrylate or 2-ethylhexyl methacrylate; an acrylate such as methyl acrylate, ethyl acrylate, or butyl acrylate; and vinyl cyanide compound such as acrylonitrile or methacrylonitrile. These vinyl monomers may be used alone or in combination as a mixture of two or more different types. Of these vinyl monomers, a methacrylate is preferable, with methyl methacrylate particularly preferable.

The proportions of the compound rubber and the vinyl monomer in the compound rubber type graft copolymer are preferably such that the compound rubber is 30 to 95 wt. %, preferably 40 to 90 wt. %, and the vinyl monomer is 5 to 70 wt. %, preferably 10 to 60 wt. %, based on the weight of the graft copolymer.

The vinyl monomer is added to a latex of the compound rubber and then polymerized in a single step or in multi-steps by a radical polymerization technique to obtain a latex of the compound type graft copolymer. The latex thus obtained is poured into hot water in which a metal salt such as calcium chloride or magnesium sulfate is dissolved, followed by salting out and coagulation to separate and recover the compound rubber type graft copolymer.

The preparation of the inventive composition may be carried out by conventional means and by following conventional procedures. The composition may contain any of the known and conventionally used functional additives such as pigments, fillers and reinforcing agents, UV-stabilizers, thermal-stabilizers, hydrolytic stabilizers and flame retarding agents as well as mold release agents and the like.

Experimental

In carrying out the experiments leading to the present invention use was made of the following materials:
Polycarbonate: Makrolon 2458 polycarbonate, a product of Bayer Polymers LLC: a Bisphenol-A based homopolycarbonate having a melt flow rate (MFR) of 20 g/l 0 min. under 300° C./1.2 kg condition.
SAN: Styrene-acrylonitrile copolymer with AN of 23% and weight average molecular weight of 140,000 g/mole.
   IM1 Paraloid EXL 3361, a product of Rohm and Haas; Poly(butyl acrylate) grafted with poly(methyl methacrylate). Particle size (weight-average) of about 0.20 micrometers.
   IM2 Metablen S-2001, a product of Mitsubishi Rayon Company; an impact modifier in accordance with the invention; Particle size (weight-average) of about 0.25 micrometers.

All the compositions evaluated further contained conventional internal mold release agent, an antioxidant, a UV absorber and pigment, none believed to be critical in the present context.

The compounding and molding of the compositions followed conventional procedures as follows:

Compounding

| | |
|---|---|
| Extruder: | Leistritz twin-screw extruder |
| Melt Temperature: | Set at 240° C. for Zone-1 to 5 |
| | Set at 250° C. for Zone-6 to 10, and |
| | die |
| Screw Speed: | 250 rpm |

Injection Molding

| | |
|---|---|
| Molding Machine: | Cincinnati Milacron, Boboshot 110T |
| Melt Temperature: | Set at 500° F. for Zone-1, 2, 3 and |
| | nozzle, respectively |
| Mold Temperature: | Set at 170° F. |

Evaluations of the compositions were conducted in accordance with the standards and procedures set forth below:

Testing

| | |
|---|---|
| Melt flow rate (MFR) | According to ASTM D1238 at 260° C./5 Kg |
| g/10 min. | load. |
| Izod (⅛″) | In accordance with ASTM D256. Tests |
| Izod (¼″) | were run at room temperature. The |
| | samples measured 6.35 cm × 1.27 cm × indicated |
| | thickness. The test specimens |
| | were milled with a 0.25 cm radius notch at |
| | midpoint to a remaining height of 10.2 mm. |
| Tensile Strength | Tensile properties--Tests were run at |
| @ Yield, MPa | room temperature using an Instron |
| Elongation @ Fail, % | universal machine with cross-head speed |
| Tensile Modulus, Gpa | of 50 mm/minute in accordance with |
| | ASTM D-638. Type I tensile bars were |
| | used. Cross-head speed of 5 mm/minutes |
| | for Modulus. |

The results of the evaluations are shown in Table 1 below:

Polycarbonate Resin Composition

| | C-1 | C-2 | C-3 | E-1 | E-2 | E-3 |
|---|---|---|---|---|---|---|
| Polycarbonate, | 37 | 56 | 76 | 37 | 56 | 76 |
| wt. % | | | | | | |
| SAN, wt. % | 63 | 44 | 24 | 63 | 44 | 24 |
| IM1, pph⁽¹⁾ | 24 | 13 | 8 | 0 | 0 | 0 |
| IM2. pph | 0 | 0 | 0 | 24 | 13 | 8 |
| MFR, g/10 min. | 37.5 | 39.6 | 34.2 | 24.5 | 35.2 | 29.2 |
| Izod (⅛″), ft- | 3.1 | 8.6 | 8.1 | 4.8 | 7.3 | 10.5 |
| lb/in | | | | | | |
| Izod (¼″), ft- | 2.7 | 3.8 | 3.5 | 4.1 | 4.5 | 9.0 |
| lb/in | | | | | | |
| Tensile | 55.9 | 61.6 | 65.7 | 49.6 | 59.7 | 58.9 |
| Strength @ | | | | | | |
| Yield, MPa | | | | | | |
| Tensile | 12.5 | 23.7 | 33.6 | 21.0 | 27.1 | 37.6 |
| Elongation. @ | | | | | | |
| Break, % | | | | | | |
| Tensile | 2.78 | 2.92 | 2.91 | 2.61 | 2.90 | 2.74 |
| Modulus, GPa | | | | | | |

⁽¹⁾pph: parts by weight per one hundred parts by weight of resin.

The tabulated results show the advantageous impact properties of the inventive compositions (E-1, E-2 and E-3). A comparison of these compositions to corresponding compositions (C-1, C-2 and C-3) wherein a different impact modifier was used points to these advantages most notably in respect to Izod at ¼″.

Although the invention has been described in detail in the foregoing for the purpose of illustration, it is to be understood that such detail is solely for that purpose and that variations may and can be made therein by those skilled in the art without departing from the spirit and scope of the invention except as it may be limited by the claims.

1. A thermoplastic molding composition comprising
(A) 10 to 99 percent of aromatic polycarbonate resin, and
(B) 90 to 1 percent of a vinyl (co)polymer and
(C) 1 to 30 parts per one hundred parts by weight of the total of A and B (pph) of a compound rubber graft copolymer, said graft copolymer being a product of graft polymerization of one or more vinyl monomers onto a compound rubber having a weight average particle diameter of 0.01 to 10 microns and containing 1 to 10% relative to its weight of a polyorganosiloxane rubber component and 90 to 99% relative to its weight of a polyalkyl (meth)acrylate rubber component, said components inseparably entangled.

2. The composition of claim 1, wherein the weight average particle diameter is 0.04 to 1 μm.

3. The composition of claim 1, wherein the polyorganosiloxane rubber component is present in an amount of 3 to 10 wt. %.

4. The composition of claim 1, wherein the polyorganosiloxane rubber component is present in an amount of 5 to 10 wt. %.

5. The thermoplastic molding composition of claim 1, wherein (A) is present in an amount of 20 to 95 percent, (B) is present in an amount of 8 to 5 percent and (C) is present in an amount of 2 to 25 pph.

6. The thermoplastic molding composition of claim 1, wherein (A) is present in an amount of 40 to 90 percent, (B) is present in an amount of 6 to 10 percent and (C) is present in an amount of 2 to 15 pph.

7. The thermoplastic molding composition of claim 1, wherein the vinyl (co)polymer is a product of polymerization of at least one monomer selected from the group consisting vinyl aromatics, vinyl cyanides, (meth)acrylic acid (C₁-C₈) alkyl esters, unsaturated carboxylic acids and derivatives of unsaturated carboxylic acids.

8. The thermoplastic molding composition of claim 1, wherein the vinyl (co)polymer is a product of polymerization of at least one monomer selected from the group consisting of styrene, α-methyl styrene, acrylic acid, methacrylic acid, methacrylic acid (C₁ to C₄) alkyl ester, acrylonitrile and maleic anhydride.

9. The thermoplastic molding composition of claim 1, wherein the vinyl (co)polymer is a copolymer of
50 to 99 wt. % of at least one monomer selected from the group consisting of vinyl aromatic, ring-substituted vinyl aromatics, methacrylic acid (C₁-C₈) alkyl esters and
1 to 50 wt. % of at least one monomer selected from the group consisting of vinyl cyanides (meth)acrylic acid (C₁-C₈) alkyl esters and derivatives of unsaturated carboxylic acids.

10. The thermoplastic molding composition of claim 1, wherein the vinyl (co)polymer is a copolymer styrene and acrylonitrile wherein content of acrylonitrile is 15 to 35 percent relative to the weight of the copolymer.
